(19) United States
(12) Patent Application Publication
(10) Pub. No.: US 2005/0221025 A1
(43) Pub. Date: Oct. 6, 2005

(54) Ink-jet recording sheets and production process thereof

(76) Inventors: Akira Kita, Ibaraki (JP); Kenichi Kawano, Ibaraki (JP); Hayato Tomihara, Ibaraki (JP); Hiroshi Kakihira, Ibaraki (JP); Koji Fujimoto, Ibaraki (JP)

Correspondence Address: HARNESS, DICKEY & PIERCE, P.L.C., P.O. BOX 8910, RESTON, VA, 20195, US

(21) Appl. No.: 10/504,073

(22) PCT Filed: Apr. 30, 2003
(86) PCT No.: PCT/JP03/05543

§ 371 Date: Aug. 9, 2004

(30) Foreign Application Priority Data
Apr. 30, 2002 (JP) NO. 2002-127899

(51) Int. Cl. B41M 5/00

(52) U.S. Cl. 428/32.18

(57) ABSTRACT

An ink-jet recording sheet includes a substrate and an ink-receiving layer. The substrate is composed of a base material and polyolefin coating layers formed on opposite sides of the base material, respectively, by coating the base material at the opposite sides thereof with a polyolefin. The ink-receiving layer is composed of an alumina hydrate as a principal component and is formed on one of the polyolefin coating layers. The substrate curls toward the other one of the polyolefin coating layers to present a concave curl on a side of the other polyolefin coating layer and a convex curl on a side of the one polyolefin coating layer when the substrate is subjected to heat treatment at 60° C. and a relative humidity not higher than 45%.

### TECHNICAL FIELD

This invention relates to ink-jet recording sheets (hereinafter abbreviated as “recording sheets”) suitable for performing recording by ink-jet recording and also to a production process thereof. More specifically, this invention is concerned with recording sheets, which can form images having texture and high gloss close to those of silver halide pictures and can also exhibit good curling characteristics even under environments ranging from low humidity to high humidity, and also with a production process thereof.

### BACKGROUND ART

Ink-jet recording features high-speed printing performance, low operating noise, applicability for the recording of a wide variety of characters and patterns, and further, easy multi-color printing. Ink-jet recording has increasingly found wide-spread utility in a variety of fields as they can form images of quality comparable with that of silver halide pictures owing to technological innovations in recent years.

Keeping in step with this, demands for still higher properties have also arisen on recording sheets. Recording sheets are required to meet the move towards multicolor printing and high-quality images in printers, and even in ink-jet images, it is begun to be considered very important to have surface gloss and texture similar to those of silver halide pictures.

For these demands, a variety of proposals have been made to date. Among these, recording sheets—each of which carries an ink-receiving layer formed on a substrate (which may hereinafter be called “a coated paper sheet”) obtained by coating a paper sheet at opposite sides with a resin such as a polyolefin—are high in gloss and texture, and are rapidly finding wide-spread utility as silver-halide-like recording sheets in recent years.

As ink-receiving layers for arrangement on such coated paper sheets, numerous ink-receiving layers with fine inorganic particles contained therein have been proposed (JP 8-174992 A and JP 10-175365 A). These ink-receiving layers have good handling, because they have a high ink-absorbing speed and are free of stickiness.

Of these, recording sheets each of which is coated with an ink-receiving layer containing an alumina hydrate as fine inorganic particles as proposed especially in JP 2000-301829 A, for example, feature a still higher gloss and a high image density, and make it possible to obtain images still closer to silver halide pictures among recording sheets making use of coated paper sheets.

On the other hand, recording sheets each of which carries an ink-receiving layer on a coated paper sheet are, however, accompanied by a drawback that their curling substantially varies depending on changes in humidity. From the standpoint of external attractiveness when placed on a flat surface and also from the standpoint of printing applicability, a recording sheet is generally desired to be in an uncurled form or in a form slightly curled toward a side (hereinafter called “the back side”) opposite to an ink-receiving layer to present a concave curl on the side of the back side.

To overcome the above-described drawback, a variety of methods are conventionally known for the control of curling of coated paper sheets, including the following illustrative examples:
1. To control the curling of a base material (for example, an uncoated paper sheet) itself.
2. To change the thickness of a polyolefin between the front side and the back side.
3. To change the composition of a polyolefin resin between the front side and the back side.
4. To change the density of a polyolefin between the front side and the back side.

In practice, the control of curling is effected by combining two or more of these methods.

However, the curling of a recording sheet subsequent to the formation of an ink-receiving layer is attributed to an interaction among the paper sheet, the coated polyolefin and the ink-receiving layer. With control of curling of the substrate alone, no sufficient effect can be exhibited especially because the behavior of curling varies considerably depending on the kind and properties of the ink-receiving layer.

With a view to overcoming the above-mentioned problem, JP 2001-10203 A discloses a method for controlling curling of a recording sheet which carries an ink-recording sheet arranged on a substrate obtained by coating a paper sheet at opposite sides thereof with a polyolefin resin. Effects on curling by differences in ink-receiving layer are, however, not considered practically in this patent. Actually, the control of curling is effected by relying solely upon physical properties of the base material, so that this invention is not considered to show effects fully.

With the foregoing current circumstances in view, the present invention has as an object thereof the provision of a recording sheet which can form images having texture and high gloss close to those of silver halide pictures and can also exhibit good curling characteristics even under environments ranging from low humidity to high humidity.

The present invention also has as another object thereof a process for the production of such a recording sheet.

### DISCLOSURE OF THE INVENTION

The present inventors have proceeded with extensive investigations. As a result, the present inventors have found that curling of a coated paper sheet when it is subjected to heat treatment affects curling of a recording sheet available after formation of an ink-receiving layer, and the present inventors have also found coated paper sheets each of which is suited for the formation of an ink-receiving layer composed of an alumina hydrate as a principal component. These findings have now led to the completion of the present invention.

In one aspect of the present invention, there is thus provided an ink-jet recording sheet including a substrate, said substrate being composed of a base material and polyolefin coating layers formed on opposite sides of the base material, respectively, by coating the base material at the opposite sides thereof with a polyolefin, and an ink-receiving layer composed of an alumina hydrate as a principal component and formed on one of the polyolefin coating layers, characterized in that the substrate curls toward the other one of the polyolefin coating layers to present a concave curl on a side of the other polyolefin coating layer and a convex curl on a side of the one polyolefin coating layer when the substrate is subjected to heat treatment at 60° C. and a relative humidity not higher than 45%. Preferably, the polyolefin may be polyethylene, the polyethylene may consist of a first type of polyethylene and a second type of polyethylene having a density lower than the first type of polyethylene, and the other polyolefin coating layer may be formed of the first type of polyethylene, and the one polyolefin coating layer may be formed of the second type of polyethylene. It is preferred that the ink-receiving layer has been formed by applying a coating formulation at a rate of 0.5 to 60 g/m² in terms of solids.

In another aspect of the present invention, there is also provided a process for the production of an ink-jet recording sheet including a substrate, said substrate being composed of a base material and polyolefin coating layers formed on opposite sides of the base material, respectively, by coating the base material at the opposite sides thereof with a polyolefin, and an ink-receiving layer composed of an alumina hydrate as a principal component and formed on one of the polyolefin coating layers, characterized in that the substrate curls toward the other one of the polyolefin coating layers to present a concave curl on a side of the other polyolefin coating layer and a convex curl on a side of the one polyolefin coating layer when the substrate is subjected to heat treatment at 60° C. and a relative humidity not higher than 45%; and the process comprises applying onto the one polyolefin coating layer a coating formulation for an ink-receiving layer, and then conducting drying of the thus-applied coating formulation at such a temperature that the resulting ink-receiving layer is heated to a surface temperature of at least 80° C.

Owing to the above-described construction and production process, the recording sheet according to the present invention can form images having texture and high gloss close to those of silver halide pictures, and can also exhibit good curling characteristics even under environments ranging from low humidity to high humidity.

In research conducted by the present inventors, it was found that on the curling of a recording sheet with an ink-receiving layer formed on a coated paper sheet and composed of an alumina hydrate as a principal component, curling characteristics of the coated paper sheet after subjected to heat treatment at 60° C. and a relative humidity not higher than 45% give stronger effects than curling characteristics of the coated paper sheet in an ordinary state. The term “heat treatment” as used herein means that the coated paper is allowed to stand for 10 minutes under the above-described humidity and temperature conditions.

### BEST MODES FOR CARRYING OUT THE INVENTION

The present invention will next be described more specifically based on certain preferred embodiments.

As the base material for use in the substrate which is employed in the recording sheet according to the present invention, a conventionally-used paper sheet can be employed, and no particular limitation is imposed on the base material. No particular limitation is imposed on wood pulp. Illustrative are chemical pulp and mechanical pulp, although use of chemical pulp is preferred. For the provision of better surface feeling (formation) subsequent to coating, it is more preferred to primarily use LBKP or the like, which is high in the content of short fibbers. In the base material, commonly-employed, paper-making additives such as paper strength agents, fillers, binders and fluorescent whitening agents can be added as needed.

No particular limitation is imposed on the thickness of the base material, although the preferred thickness may range from 50 to 300 μm. A thickness smaller than 50 μm results in a recording sheet, the rigidity and texture of which are substantially different from those of silver halide pictures. A thickness greater than 300 μm, on the other hand, involves a high potential problem in the transportability of the recording sheet upon printing. Subsequent to a paper making step, calendering can also be applied in one way or another to control the thickness and at the same time, to improve the surface smoothness.

As polyolefins usable in the present invention, polymers and copolymers of ethylene and propylene can be mentioned. In view of the matching with the associated base material, it is necessary to choose a polyolefin material such that it conforms with the curling characteristics of the substrate employed in the present invention. A white pigment such as titanium dioxide or zinc oxide can also be added to the polyolefin to provide increased opacity or whiteness. As other additives, fluorescent whitening agents, antioxidants, dyes, dipersants and the like can be used as desired.

Among the above-described polyolefin materials, use of polyethylene is preferred for its processability and cost. As the polyethylene to be coated on the opposite sides of the base material, it may consist of a single type of polyethylene so that the polyethylene coated on one side of the base material and that coated on the other side of the base material have the same density. As an alternative, the polyethylene may consists of two types of polyethylene having different densities so that the polyethylene coated on one side of the base material and that coated on the other side of the base material are different in density. When a single type of polyethylene is used, its thickness on the side of one of the opposite sides of the base material can be rendered different from that on the side of the other side of the base material such that the one side of the base material, on which the ink-receiving layer is to be formed, curls to present a convex curl. When two types of polyethylene having different densities are used, on the other hand, one having a lower density can be applied on the one side of the base material, on which the ink-receiving layer is to be formed, and one having a higher density can be applied to the other side of the base material. Use of a single type of polyethylene or two types of polyethylene in the above-described manner makes it possible to more readily bring about the advantageous effects of the present invention.

When heated, polyethylene progressively undergoes crystallization, and as a result, shrinks. Because a higher density allows crystallization to advance more readily, the higher density tends to result in stronger shrinkage. When a base material is coated at its front and back sides with two types of polyethylene, the densities of which are different from each other, respectively, the resulting substrate is therefore considered to curl toward the side on which the polyethylene having the higher density is used.

Each polyolefin coating layer can be formed by applying polyolefin onto a running base material by die coating. The base material and the thus-applied polyolefin coating layer are bonded together under pressure through press rolls and cooling rolls. By separating the thus-coated base material from the cooling rolls, a coated paper sheet is obtained as a substrate. Here, gloss finish, matt finish, emboss finish or the like can be applied to one or both of the coated surfaces by choosing desired cooling rolls.

No particular limitation is imposed on the thicknesses of the coating layers, but a range of from 5 to 50 μm is preferred, with 8 to 40 μm being more preferred. It is, however, necessary to choose such thicknesses as conforming with the curling characteristics in the present invention, because the curling characteristics of a coated paper sheet vary depending on the thicknesses of the coating layers on the front and back sides. It is also possible to apply corona discharge treatment, flame treatment, undercoating treatment or the like to the surfaces of the polyolefin coating layers.

In the present invention, an alumina hydrate is used as a principal component in the ink-receiving layer. As mentioned above, the use of the alumina hydrate makes it possible to obtain a recording sheet which has a high gloss and can form images of high density.

The alumina hydrate for use in the present invention includes one represented by the following formula (1):
Al₂O₃₋ₙ(OH)₂ₙ.mH₂O (1)
wherein n stands for any one of integers 0, 1, 2 and 3, and m stands for a value of from 0 to 10, preferably from 0 to 5.

Because mH₂O represents a removable water phase which may not take part in the formation of a crystal lattice in many instances, m can stand for a value which is not an integer. It is to be noted that m may reach the value of 0 when an alumina hydrate of this sort is subjected to calcination.

In general, an alumina hydrate showing the boehmite structure is a layer compound the (020) crystal plane of which forms a huge plane, and shows a particular diffraction peak in its X-ray diffraction pattern. As the boehmite structure, it is possible to take, in addition to complete boehmite structure, a structure containing excess water between layers of (020) planes and called “pseudo-boehmite”. An X-ray diffraction pattern of this pseudo-boehmite shows a broader diffraction peak than complete boehmite. As complete boehmite and pseudo-boehmite are not clearly distinguishable from each other, they will hereinafter be collectively called an alumina hydrate showing the boehmite structure.

As the form of the alumina hydrate in the present invention, its average particle size may be preferably in a range of from 150 nm to 250 nm, more preferably in a range of from 160 nm to 230 nm for obtaining an ink-receiving layer of high gloss and high transparency. An alumina hydrate the average particle size of which is smaller than 150 nm leads to a reduction in ink absorption property so that, when printed by a printer of high jetting rate or a printer of high output speed, bleeding or beading (a phenomenon in which particulate irregularity in density appears due to a failure in absorbing ink) may occur. An average particle size greater than 250 nm, on the other hand, results in an ink-receiving layer lowered in transparency and also in strength.

Further, the alumina hydrate for use in the present invention may preferably have a BET specific surface area of from 40 to 500 m²/g. A BET specific surface area smaller than 40 m²/g means large alumina hydrate particle, results in an ink-receiving layer with impaired transparency, and, when printed, tends to give images which look as if covered with a white haze. A BET specific surface area greater than 500 m²/g, on the other hand, requires a great deal of an acid for the deflocculation of the alumina hydrate. More preferably, the BET specific surface area may be in a range of from 50 to 250 m²/g, with a range of from 50 to 150 m²/g being particularly preferred. The preferred range gives an ink-receiving layer excellent in ink absorption property, beading resistance, smoothness and the like.

In the coating formulation composed of the alumina hydrate useful in the practice of the present invention, an aqueous resin may be added as a binder. The aqueous resin can be a water-soluble or water-dispersible, high molecular compound. Illustrative of the water-soluble or water-dispersible, high molecular are starch, gelatin and casein, and modified products thereof; cellulose derivatives such as methylcellulose, carboxymethylcellulose and hydroxyethylcellulose; completely or partially saponified polyvinyl alcohols and modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes. Among these, preferred is polyvinyl alcohol having an average polymerization degree of from 300 to 5,000. Its saponification degree may preferably be from 70 to lower than 100%, with 80 to 99.5% being particularly preferred. These water-soluble or water-dispersible resins can be used either singly or in combination.

The aqueous resin can be used preferably in a range of from 1/30 to 1/1, more preferably from 1/20 to 1/3 in terms of its mixing weight ratio to the alumina hydrate. Setting of the proportion of the aqueous resin within this range makes it possible to provide the resulting ink-receiving layer with resistance to crazing or separation as dust and also with good ink absorption property.

To the ink-receiving layer of the recording sheet according to the present invention, hardeners, dye fixatives, mordant dyes, mordant pigments, dispersants, thickeners, pH adjusters, lubricants, flow modifiers, surfactants, antistatic agents, defoamers, penetrants, fluorescent whitening agents, ultraviolet absorbers, antioxidants and the like can be added to extents not impairing its performance as a recording sheet.

No particular limitation is imposed on the concentration of solids in the coating formulation usable in the present invention to form an ink-receiving layer, insofar as the coating formulation has a viscosity on such an order that the ink-receiving layer can be formed on the coated paper sheet. The preferred solid concentration may, however, range from 5 to 50% by weight based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt. %, on the other hand, results in a coating formulation of high viscosity, and the coatability may be reduced in some instances.

To apply such a coating formulation to a substrate, a conventionally-known coating method can be used, such as spin coating, roll coating, blade coating, air knife coating, gate roll coating, bar coating, size pressing, spray coating, gravure coating, curtain coating, rod blade coating, lip coating, or slit die coating. Subsequent to the coating, the surface smoothness of the ink-receiving layer can be improved by using a calender roll or the like as needed.

A desired coat weight may be chosen for the coating formulation depending on an ink absorption required for the ink-receiving layer. However, care should be exercised because curling is affected more as the coat weight increases. As the coat weight, the preferred range is from 0.5 to 60 g/m², and the more preferred range is from 5 to 50 g/m², both, in terms of solids. A coat weight smaller than 0.5 g/m² may result in formation of an ink-receiving layer which, when ink is applied, cannot absorb water sufficiently from the ink so that the ink may run off or an image may bleed. Even if the coat weight exceeds 60 g/m², on the other hand, marked advantageous effects may not be brought about on the ink absorbing performance to such extent as expected.

The recording sheet according to the present invention can be obtained by applying the coating formulation to the substrate and drying the thus-applied coating formulation in a drier such as a hot air drier, hot drum or far-infrared drier. In this case, heating of the ink-receiving layer to a surface temperature of 80° C. or higher, preferably, from 80 to 120° C. makes it possible to surely bring about the advantageous effects of the present invention and hence, to lead to preferred results. The coated paper sheet tends to curl more toward the back side by making the drying time longer or raising the surface temperature of the ink-receiving layer. It is, however, necessary to exercise care in this respect because defects may occur on the front and back side if the quantity of heat applied is excessively large. The term “surface temperature” as used herein means the highest temperature at the surface of the ink-receiving layer during the drying step.

In the present invention, the substrate curls toward one of opposite sides thereof when it is subjected to heat treatment at 60° C. and a relative humidity not higher than 45%. The substrate may present preferably a curl of from −40 mm to −3 mm, more preferably from −30 mm to −10 mm when subjected to heat treatment for 10 minutes at 60° C. and a relative humidity not higher than 45%. If an ink-receiving layer is formed on a substrate which presents a curl greater than −40 mm, the substrate tends to present a strong curl after stored in an environment of low temperature and low humidity. If an ink-receiving layer is formed on a substrate which presents a curl smaller than −3 mm, on the other hand, the substrate also tends to present a strong curl after stored in an environment of high temperature and high humidity. Use of such substrates leads to reductions in external attractiveness and printing applicability.

Depending on the materials making up the ink-receiving layer, the ink-receiving layer shows such tendency that for hygroscopic action, it extends in a high-humidity state but contracts in a low-humidity state. Conversely to the above-described general tendency, the ink-receiving layer composed primarily of the alumina hydrate useful in the present invention tends to contract in a high-humidity state and to extend in a low-humidity state, and in particular, exhibits more pronounced tendency of contraction in a high-humidity state.

It is desired for a recording sheet to be in an uncurled state or in a state slightly curled toward the back side as mentioned above. A coated paper sheet is required to be in a state curled toward the back side when an ink-receiving layer composed primarily of an alumina hydrate useful in the practice of the present invention is formed. Curling of the coated paper sheet, however, considerably changes after the heating and drying step subsequent to the formation of an ink-receiving layer. By using such a coated paper sheet that curls toward one side thereof to present a concave curl when subjected to heat treatment and further, by forming an ink-receiving layer on the side opposite to the first-mentioned side, it is possible to obtain a recording sheet having good curling characteristics even under environments ranging from low humidity to high humidity. Curling can be controlled more effectively when such a coated paper sheet is used and the surface temperature of an ink-receiving layer is heated to 80° C. or higher during a drying step.

No particular limitation is imposed on ink to be used upon making a record on the recording sheet according to the present invention. It is, however, preferred to use general water-base ink for ink-jet recording, in which a dye or pigment is used as a colorant, a mixture of water and a water-miscible organic solvent is used as a medium, and the dye or pigment is dissolved or dispersed in the medium.

### EXAMPLES

The present invention will hereinafter be described specifically based on Examples and Comparative Examples, in which each designation of “part” or “parts” or “%” is on a weight basis unless otherwise specifically indicated.

### Example 1

<Preparation of a Coated Paper Sheet>

On a surface (on which an ink-receiving layer was to be formed) of a base material (base material A) which had been obtained by subjecting to calendering a wood-free paper sheet (160 g/m²) composed of LBKP as a principal raw material, low-density polyethylene (LDPE, density: 0.914 g/cm³) was applied to a thickness of 30 μm by die coating, and then, calendering was applied. On the opposite side, high density polyethylene (HDPE, density: 0.945 g/cm³) was applied to a thickness of 30 μm by die coating, and then, matt finish was applied. Further, corona discharge treatment was applied to the LDPE coating layer to produce a coated paper sheet. The coated paper sheet was subjected to heat treatment for 10 minutes in an oven controlled at 60° C. and a relative humidity not higher than 45%, and a curl was measured in the following manner.

<Preparation of a Dispersion of Alumina Hydrate>

Following the process disclosed in U.S. Pat. No. 4,242,271, aluminum dodexide was prepared. Following the process disclosed in U.S. Pat. No. 4,202,870, the aluminum dodexide was then hydrolyzed to prepare an alumina slurry. Water was added to the alumina slurry until the content of an alumina hydrate having the boehmite structure reached 7.7%. At that time, the pH of the alumina slurry was 9.4. A 3.9% nitric acid solution was added to the slurry to adjust its pH.

Using an autoclave, the slurry (pre-aging pH: 6.0) was then subjected to aging (aging temperature: 150° C., aging time: 6 hours) to obtain a colloidal sol. The colloidal sol was spray-dried into an alumina hydrate powder at an inlet temperature of 120° C. The powder so obtained was an alumina hydrate, the particle shape and crystal structure of which were plate-like and the boehmite structure, respectively. Using a specific surface area and pore distribution measuring instrument (“Micromeritics ASAP2400”, trade name; manufactured by Shimadzu Corporation), the BET specific surface area of the thus-obtained powder was measured. It was found to be 140.2 m²/g. An alumina hydrate dispersion was then prepared by mixing the alumina hydrate powder, which had the boehmite structure, in deionized water such that its concentration became 19.0%. The thus-obtained alumina hydrate dispersion was measured using a laser diffraction particle size analyzer (“PARIII”, trade name; manufactured by OTSUKA ELECTRONICS CO., LTD.). The average particle size of particles of the alumina hydrate was determined to be 178.3 nm.

<Preparation and Application of a Coating Formulation Useful for the Formation of an Ink-Receiving Layer>

In the alumina hydrate dispersion, a 3% aqueous solution of boric acid (12.7 parts, 2% based on the alumina hydrate) was mixed. To the resultant mixture, a solution of polyvinyl alcohol (5 parts; “PVA-224”, trade name; product of Kuraray Co., Ltd.) in deionized water (45 parts) was added to prepare a coating formulation useful for the preparation of an ink-receiving layer. The coating formulation was then applied to the front side of the above-produced, coated paper sheet (the side on which the ink-receiving layer was to be applied) by a wire bar to give a dry coat weight of 30 g/m². The coated paper with the coating formulation applied as described above was dried with hot air for 15 minutes in an oven controlled at 110° C. to obtain a recording sheet. At that time, the surface temperature of the resultant ink-receiving layer was measured immediately before the recording sheet was taken out of the oven.

### Example 2

A recording sheet was prepared in a similar manner as in Example 1 except that the dry coat weight of the ink-receiving layer was changed to 15 g/m². Immediately before the recording sheet was taken out of the oven, the surface temperature of its ink-receiving layer was measured.

### Example 3

A recording sheet was prepared in a similar manner as in Example 1 except that the dry coat weight of the ink-receiving layer was changed to 50 g/m². Immediately before the recording sheet was taken out of the oven, the surface temperature of its ink-receiving layer was measured.

### Example 4

A recording sheet was prepared in a similar manner as in Example 1 except that upon formation of the ink-receiving layer, the drying conditions were changed to 90° C. and 20 minutes. Immediately before the recording sheet was taken out of the oven, the surface temperature of its ink-receiving layer was measured.

### Example 5

A substrate and a recording sheet were prepared in a similar manner as in Example 1 except that as the coating layers, HDPE was applied to 20 μm on the front side and HDPE was applied to 40 μm on the back side. Immediately before the recording sheet was taken out of the oven, the surface temperature of its ink-receiving layer was measured.

### Comparative Example 1

A substrate and recording sheet were prepared in a similar manner as in Example 1 except that as the coating layers, HDPE was applied to 30 μm on the front side and LDPE was applied to 30 μm on the back side. Immediately before the recording sheet was taken out of the oven, the surface temperature of its ink-receiving layer was measured.

### Comparative Example 2

A substrate and recording sheet were prepared in a similar manner as in Example 1 except that as the coating layers, HDPE was applied to 30 μm on the front side and HDPE was applied to 30 μm on the back side. Immediately before the recording sheet was taken out of the oven, the surface temperature of its ink-receiving layer was measured.

<Measuring Method of Curls of Substrates>

Each substrate, which had been cut into the A4 size, was subjected to heat treatment as described above, and then left it sealed into the plastic bag for 5 hours under conditions of 20° C. and 65% RH. After taked it out, left over with its LDPE coating layer up for 1 hour on a horizontal desk under the same conditions. Rises at its four corners were then measured. Rises at its four corners were then measured. It was turned over, and rises at its four corners were measured. The largest one of the eight rises so measured was recorded as a curl value. The result is presented in Table 1. It is to be noted that a curl toward the front side (on which an ink-receiving layer was to be formed) will be designated by “+” whereas a curl toward the opposite side will be designated by “−”.

<Measuring Method of Curls of Recording Sheets>

Under two environments, one being 30° C. and 80% RH(H/H) and the other 15° C. and 10% RH (L/L), curls were measured by the above-described measuring method of curls of substrates. The results are presented in Table 1. It is to be noted that in the size of the recording sheets prepared in the Examples, a curl scarcely causes a problem in an actual application when it falls within a range of from −15 to +10 mm but tends to develop serious problems in external attractiveness and printing applicability when it is greater than −20 mm or +15 mm.

TABLE 1

| | | | Property of | | | | |
|---|---|---|---|---|---|---|---|
| | Constitution of | | substrate | | Drying | | |
| | Resin coatings | | Curl after | | conditions | Curls of | |
| Example/ | Front | | heat | Coat | Surface | recording sheet | |
| Comp. Ex. | side | Back side | treatment | weight | temperature | H/H | L/L |

| | | | | | | | | |
|---|---|---|---|---|---|---|---|---|
| Ex. | 1 | LDPE 30 μm | HDPE 30 μm | −30 mm | 30 g/m² | 105° C. | −3 mm | −10 mm |
| | 2 | LDPE 30 μm | HDPE 30 μm | −30 mm | 15 g/m² | 109° C. | −5 mm | −10 mm |
| | 3 | LDPE 30 μm | HDPE 30 μm | −30 mm | 50 g/m² | 103° C. | +6 mm | −12 mm |
| | 4 | LDPE 30 μm | HDPE 30 μm | −30 mm | 30 g/m² | 85° C. | +3 mm | −7 mm |
| | 5 | HDPE 20 μm | HDPE 40 μm | −10 mm | 30 g/m² | 107° C. | +6 mm | −4 mm |
| Comp. | 1 | HDPE 30 μm | LDPE 30 μm | +23 mm | 30 g/m² | 105° C. | +35 mm | +25 mm |
| Ex. | 2 | HDPE 30 μm | HDPE 30 μm | +13 mm | 30 g/m² | 107° C. | +17 mm | +5 mm |

From the results of Table 1, it is understood that each recording sheet with an ink-receiving layer applied to a coated paper sheet, which curls toward the back side thereof after heat treatment, shows good curling characteristics. From the results of Example 1 and Example 4, it is also appreciated that use of polyethylene, which is lower in density than polyethylene on the back side, on the front side can bring about more advantageous effects.

### INDUSTRIAL APPLICABILITY

According to the present invention as described above, a recording sheet—which can form images having texture and high gloss close to those of silver halide pictures and can also show good curling characteristics under environments ranging from low humidity to high humidity—can be obtained by using a substrate (for example, a coated paper sheet), which has been coated at opposite sides thereof with polyolefin and curls toward one of the opposite sides when heated at 60° C., and forming an ink-receiving layer, which is composed of an alumina hydrate as a principal component, on the other side of the coated base material.

1. An ink-jet recording sheet including a substrate, said substrate being composed of a base material and high density polyethylene coating layers formed on opposite sides of said base material, respectively, by coating said base material at said opposite sides thereof with a high density polyethylene, and an ink-receiving layer composed of an alumina hydrate as a principal component and formed on one of said high density polyethylene coating layers, characterized in that said substrate curls toward the other one of said high density polyethylene coating layers to present a concave curl on a side of said other high density polyethylene coating layer and a convex curl on a side of said one high density polyethylene coating layer when said substrate is subjected to heat treatment at 60° C. and a relative humidity not higher than 45%.

2. (canceled)

3. An ink-jet recording sheet according to claim 1, wherein said ink-receiving layer has been formed by applying a coating formulation at a rate of 0.5 to 60 g/m² in terms of solids.

4. A process for the production of an ink-jet recording sheet including a substrate, said substrate being composed of a base material and high density polyethylene coating layers formed on opposite sides of said base material, respectively, by coating said base material at said opposite sides thereof with a high density polyethylene, and an ink-receiving layer composed of an alumina hydrate as a principal component and formed on one of said high density polyethylene coating layers, characterized in that said substrate curls toward the other one of said high density polyethylene coating layers to present a concave curl on a side of said other high density polyethylene coating layer and a convex curl on a side of said one high density polyethylene coating layer when said substrate is subjected to heat treatment at 60° C. and a relative humidity not higher than 45%; and said process comprises applying onto said one high density polyethylene coating layer a coating formulation for an ink-receiving layer, and then conducting drying of the thus-applied coating formulation at such a temperature that the resulting ink-receiving layer is heated to a surface temperature of at least 80° C.
